(19) United States
(12) Patent Application Publication
(10) Pub. No.: US 2026/0025610 A1
(43) Pub. Date: Jan. 22, 2026

(54) SYSTEMS, DEVICES, AND METHODS FOR PROVIDING AUDIO REPLAY CAPABILITIES

(71) Applicant: Adeia Guides Inc., San Jose, CA (US)

(72) Inventors: Jean-Yves Couleaud, Mission Viejo, CA (US); Aldis Sipolins, Somerville, MA (US); Reda Harb, Tampa, FL (US); Charles Dasher, Lawrenceville, GA (US); Ning Xu, Irvine, CA (US)

(21) Appl. No.: 18/669,906

(22) Filed: May 21, 2024

(51) Int. Cl. H04R 1/10; G06F 3/01; G10L 17/04

(52) U.S. Cl. CPC H04R 1/10; G06F 3/013; G10L 17/04

(57) ABSTRACT

Systems and methods are provided herein for providing devices (e.g., a mobile device and a hearing device) with audio replay capabilities. The hearing device receives audio data with one or more voices of one or more people present in an environment. A user wearing the hearing device is present in the environment and is distinct from the one or more people present in the environment. The hearing device stores the received audio data in a memory of the hearing device. Based on receiving an input, on either a user interface of the hearing device or a user interface of a connected mobile device, from the user wearing the hearing device while they are present in the environment, the hearing device selects a portion of the audio data to replay and causes the selected portion of the audio data to be replayed by the hearing device.

### BACKGROUND

The present disclosure is directed towards techniques for providing devices (e.g., a mobile device and a hearing device) with audio replay capabilities.

### SUMMARY

Many people have hearing disabilities, due to a medical condition and/or due to advanced age, which hinders their ability to understand a conversation that they are participating in with others. A person with hearing difficulties may have trouble hearing certain portions of conversations, especially in noisy environments, and the person with hearing difficulties may often ask the others they are conversing with to repeat what they just said. This often leads to a broken conversation which can be taxing for both the person with hearing difficulties and the other conversation participants.

In one approach, a hearing aid is employed to amplify the voices of people in the conversation to the person with hearing difficulties and potentially avoid the need for the person with hearing difficulties to ask the other people to repeat what they have just said. However, while this is useful, particularly in a one-on-one conversation with little background noise, in a conversation with multiple people (who may be randomly arranged) and/or with background noise in a relatively noisy environment, the hearing aid of the person with hearing difficulties may fail to provide a coherent, understandable amplified output of the detected sound to the person with hearing difficulties.

In another approach, the person with hearing difficulties may use a device, such as a smartphone, to record their conversation with other people, to allow the person with hearing difficulties to listen to the recording later to fill in any gaps in details of the conversation that they missed in real time. However, depending on how social the person with hearing difficulties is, such recordings of conversations may begin to consume an inordinate amount of storage space on the smartphone or other device, as the recordings may remain on the device until the person with hearing difficulties actively deletes such recordings. Moreover, it may be tedious and frustrating for the person with hearing difficulties to record conversations he or she participates in; the person with hearing difficulties may not be able to select the option to record in time to record the conversation or portion thereof at issue; and/or there may be privacy concerns related to recording all the person's conversations with others.

To overcome these problems, systems and methods are provided herein for providing devices (e.g., a mobile device and a hearing device) with audio replay capabilities. In some embodiments, the hearing device receives audio data including one or more voices of one or more people present in an environment. A user wearing the hearing device (the person with hearing difficulties) is present in the environment and is distinct from the one or more people present in the environment. In some examples, the hearing device stores the received audio data in a memory of the hearing device. In some embodiments, based on receiving an input, on a user interface of the hearing device, from the user wearing the hearing device while the user wearing the hearing device is present in the environment, the hearing device selects a portion of the audio data to replay, and causes the selected portion of the audio data to be replayed by the hearing device of the user wearing the hearing device.

Such aspects make the enhanced hearing device capable of receiving a physical input, (e.g., one or more taps from the user wearing the hearing device on the physical portion of the hearing device), a gesture-based input (e.g., the user wearing the hearing device nodding their head), or a vocal input (e.g., the user wearing the hearing device saying, “What did they just say?”) which results in replaying the last portion of the conversation by the people present in the environment to the user wearing the hearing device. This allows for seamless playback of specific portions of conversations in real time without disrupting the flow of the social interaction to help people with hearing difficulties to participate in situations with varying types of noise levels without missing out on crucial pieces of information that others are trying to communicate to them. Further, the hearing device's capability to store audio data in a temporary memory saves storage space that would otherwise be used to record all the conversations of the person with hearing difficulties.

In some embodiments, the hearing device is fitted with one or more microphones, a control circuitry, a transient memory with a certain memory capacity to store the audio that the one or more microphones capture, and a storage memory to record segments of the content to the transient memory. In some embodiments, the control circuitry of the hearing device is programmed to adjust the duration and quality of the audio saved into the storage memory based on the capacity of the memory and other control parameters such as the ambient noise level or the number of individual speakers being picked up by the one or more microphones. In some embodiments, when the hearing device is working in concert with a mobile device, a transient memory of the mobile device stores the audio that the one or more microphones capture, and a storage memory of the mobile device records segments of the content to the transient memory. In some embodiments, the hearing device deletes the audio content stored in the transient memory based on determining that the user wearing the hearing device has exited their current environment. For example, the control circuitry of the hearing device, or the connected mobile device, determines using location services that the user wearing the hearing device is no longer present in the environment that the stored audio content was recorded in, and deletes the stored audio content from the transient memory. In some embodiments, the hearing device deletes the content automatically. In some embodiments, the hearing device presents an option to the user wearing the hearing device to delete the stored content and the user wearing the hearing device can choose to delete or keep certain portions.

In some embodiments, the control circuitry of the hearing device stores voice fingerprints for people in the memory. In some implementations, distinct voices are extracted from audio data captured by the microphones of the hearing device, for example, using calibration, sound level, and spectrum measurement. In some examples, the control circuitry of the hearing device stores captured audio into a combination of indexes representing a speaker and the portion of their speech. In some embodiments, voice fingerprints are computed in real time to associate an audio segment with a detected voice. In some implementations, voice fingerprints are weights of a machine learning model used to discriminate speakers in a conversation. In some embodiments, voice fingerprints are spectral representations of voices that are matched to spectral representations of a conversation. In some embodiments, voice fingerprints are preconfigured by users to be prestored by the hearing device for future conversations. For example, when setting up the hearing device, the person wearing the hearing device pre-stores their own voice fingerprint and voice fingerprints of their family members by recording answers to prompts offered in the settings of the hearing device.

In some embodiments, when the hearing device detects a voice a certain number of times over a predetermined threshold amount that does not already have a voice fingerprint stored for it, the hearing device creates and stores a new voice fingerprint for the voice. In some embodiments, the threshold amount is preconfigured by a user in the settings of the connected mobile device for the hearing device. In some embodiments, when the hearing device detects a voice a certain number of times over a predetermined threshold amount that does not already have a voice fingerprint stored for it and the storage of the hearing device or the mobile device does not have enough capacity for new voice fingerprints, the hearing device identifies the number of user inputs associated with each existing voice fingerprint and removes the voice fingerprint with the fewest number of user inputs associated with it before storing the voice of the new user in the memory. In some embodiments, voice fingerprints come from external devices, rather than being a learned fingerprint, for example, a technologically generated voice from a mobile device for a user that is speech impaired. For example, a voice fingerprint is transferred from one device, the device of a speech-impaired user, to the earpiece or the mobile device connected to the earpiece of the user wearing the hearing device by the earpiece capturing an audio recording of the technologically generated voice from the device of the speech impaired user, or via an internet communication, e.g., email, text message, or file sharing.

Such aspects save processing power for the hearing device and the mobile device by storing commonly heard voices, so the devices don't have to initiate recognition anew for them each time the wearer of the hearing device is talking to someone they talk to often. Further, representing voice fingerprints as names, pictures, or avatars on the user interface of the mobile device makes it easier for the user wearing the hearing device to select which voice they want to replay.

In some embodiments, the hearing device is fitted with a head pose detection interface made of inertial measurement sensors, for example, accelerometers and gyrometers, as well as orientation sensors, tilt sensors, and magnetic field sensors. In some implementations, the hearing device is also fitted with or connected to an array of microphones allowing special localization of an audio source, for example, for the hearing device to associate voice fingerprints with source directions. In some examples, the hearing device keeps track of the directions of voice fingerprints as the source of each voice changes location relative to the user wearing the hearing device. In some embodiments, the selection of the target speaker whose speech needs to be repeated is based on who spoke last. In some embodiments, the selection of the target speaker whose speech needs to be repeated is based on an estimated direction of the gaze of the user wearing the hearing device (derived from the head pose of the user wearing the hearing device), e.g., who the user wearing the hearing device is looking at. In some implementations, the hearing device generates a new audio portion made of the audio captured between the last recorded timestamp in storage memory and the time the hearing device detected an activation contact gesture, identifies voice fingerprints for the voices within the portion, locates the last recorded audio portions that match the voice direction of the user head pose and plays these audio portions back to the user wearing the hearing device. In another example, playback of the audio portion is directional, for example, the hearing device recreates the direction from which the portion of audio being replayed was originally captured during playback. In another example, the hearing device may detect that the speaker of the audio portion to replay has now moved to a new position since the audio portion was recorded and the hearing device may replay the audio portion simulating the new direction. In another example, the hearing device may automatically update its directional metadata in the storage memory upon detecting that a speaker previously fingerprinted at one location has now moved to a new location. In some examples, the systems and methods herein are implemented solely on the hearing device itself. In some implementations, the hearing device manages repeats of live content.

In some embodiments, the hearing device works in concert with a mobile device. For example, the hearing device stores the received audio data in a memory of the mobile device; the hearing device receives the input from the user wearing the hearing device at the mobile device; on a user interface of the mobile device; and the hearing device causes, by the mobile device, the selected portion of the audio data to be replayed by the hearing device of the user wearing the hearing device. As another example, the hearing device receives the input from the user wearing the hearing device at the hearing device, on a user interface of the hearing device, and transfers the input signal to the mobile device to generate the portion of the stored audio data for replay.

Such aspects allow for a more advanced user interface for people with hearing difficulties to indicate that they want to replay certain portions of conversations. Further, a mobile device has more advanced storage capabilities than a hearing device and therefore can detect more voices and store and replay more conversation as audio data. This enables the hearing device to act as a simple headset with some input controls, while the processing and audio generation work is done at the mobile device.

In some embodiments, the hearing device selects the portion of the audio data to replay by determining a first timepoint within the audio data that corresponds to when the input instructing the hearing device to replay audio data was received and selecting the portion of the audio data corresponding to a last portion of the audio data that was detected prior to the first timepoint or the portion of the audio data from a second timepoint occurring at a predetermined period of time prior to the first timepoint.

In some embodiments, the hearing device selects the portion of the audio data to replay by determining a relevance of each portion of the audio. For example, the hearing device determines one or more entities within each portion of the audio data using natural language processing and compares the one or more entities within each portion of the audio data to information stored in a user profile of the user wearing the hearing device.

In some embodiments, the hearing device selects the portion of the audio data to replay by identifying a portion of the environment based on an estimated direction of the gaze or posture of the user wearing the earpiece (derived from the head pose of the user wearing the earpiece) when the input is received, identifying a person of the one or more people in the environment located at the identified portion of the environment, identifying a voice of the identified person, and selecting a portion of the audio data corresponding to the identified voice of the identified person detected prior to receiving the input.

Such aspects allow for specific selection of the exact portion that the user wearing the hearing device wants to replay. The user wearing the hearing device can request and receive a simple repeat of what was just said, as well as get more complex replays based on what a specific person just said, who the user wearing the hearing device is looking at, or the topic of conversation. This allows the user wearing the hearing device to have a complete, in-depth understanding of the conversation they are hearing, so that they can adequately participate.

### BRIEF DESCRIPTION OF THE DRAWINGS

The present disclosure, in accordance with one or more various embodiments, is described with reference to the following figures. The drawings are provided for purposes of illustration only and merely depict typical or example embodiments. These drawings are provided to facilitate an understanding of the concepts disclosed herein and do not limit the breadth, scope, or applicability of these concepts. It should be noted that for clarity and ease of illustration these drawings are not necessarily made to scale.

FIG. 1A is an illustrative example of a system for providing devices with audio replay capabilities, in accordance with some embodiments of the present disclosure;

FIG. 1B is an illustrative example of a system for providing devices with audio replay capabilities, in accordance with some embodiments of the present disclosure;

FIG. 2 is an illustrative example of a hierarchy of audio segments, in accordance with some embodiments of the present disclosure;

FIG. 3 is an illustrative example of an interface for the selection of audio segments for playback based on a selected user, in accordance with some embodiments of the present disclosure;

FIG. 4 is an illustrative example of an interface for the selection of audio segments for playback based on a point on a timeline, in accordance with some embodiments of the present disclosure;

FIG. 5 is an illustrative example of an interface for the selection of audio segments for playback based on a time range on a timeline, in accordance with some embodiments of the present disclosure;

FIG. 6 is an illustrative example of an interface for the selection of audio segments for playback based on specific time periods on a timeline, in accordance with some embodiments of the present disclosure;

FIG. 7 is a shows illustrative examples of devices with audio replay capabilities, in accordance with some embodiments of the present disclosure;

FIG. 8 is a diagram of an illustrative media device, in accordance with some embodiments of this disclosure;

FIG. 9 is a diagram of an illustrative audio replay system, in accordance with some embodiments of this disclosure;

FIG. 10 is a flowchart of an illustrative process for providing devices with audio replay capabilities, in accordance with some embodiments of the present disclosure;

FIG. 11A is a flowchart of an illustrative process for providing devices with audio replay capabilities, in accordance with some embodiments of the present disclosure;

FIG. 11B is a flowchart of an illustrative process for providing devices with audio replay capabilities, in accordance with some embodiments of the present disclosure;

FIG. 11C is a flowchart of an illustrative process for providing devices with audio replay capabilities, in accordance with some embodiments of the present disclosure;

FIG. 11D is a flowchart of an illustrative process for providing devices with audio replay capabilities, in accordance with some embodiments of the present disclosure;

FIG. 11E is a flowchart of an illustrative process for providing devices with audio replay capabilities, in accordance with some embodiments of the present disclosure;

FIG. 11F is a flowchart of an illustrative process for providing devices with audio replay capabilities, in accordance with some embodiments of the present disclosure.

### DETAILED DESCRIPTION OF EMBODIMENTS OF THE DISCLOSURE

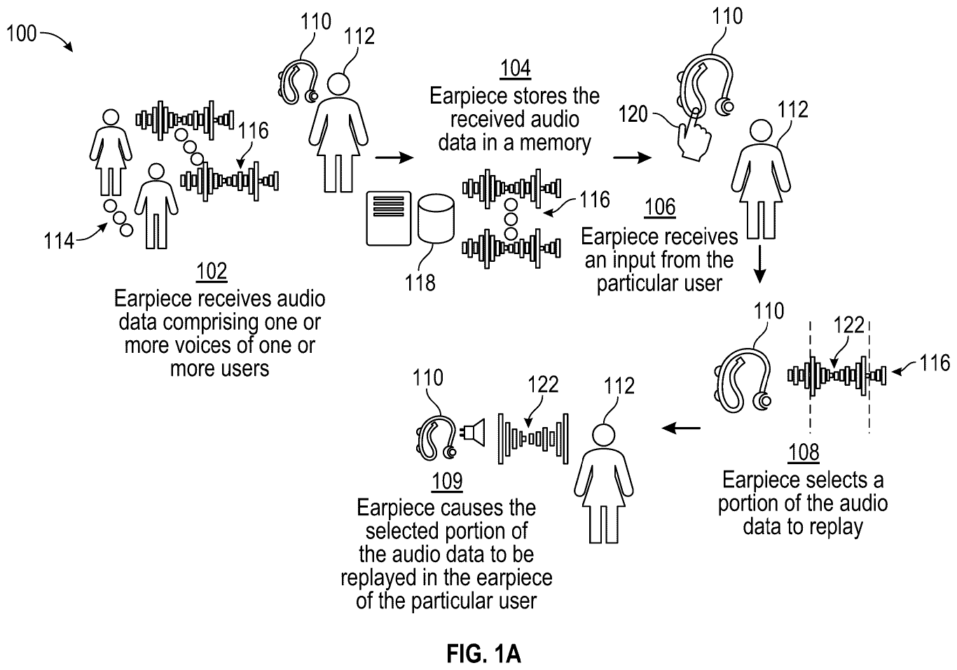

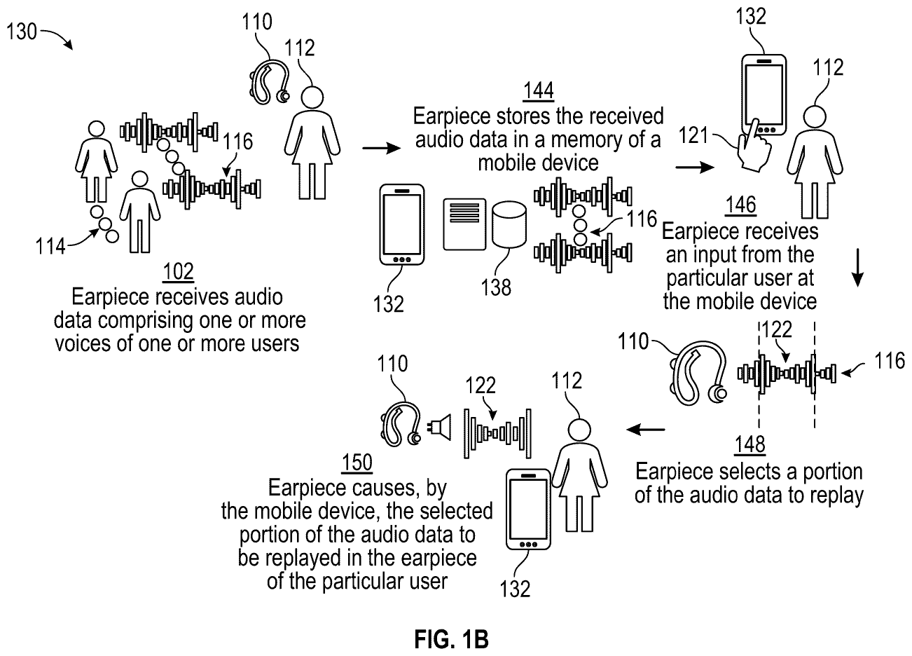

FIG. 1A is an illustrative example of a system for providing devices with audio replay capabilities, in accordance with some embodiments of the present disclosure. In some embodiments, system 100 includes earpiece 110 and memory 118. In some embodiments, memory 118 is a memory of earpiece 110. System 100 may include additional servers, devices, and/or networks. In some examples, the steps outlined within system 100 are performed by the control circuitry of earpiece 110. Earpiece 110 is being worn by user 112. In some embodiments, earpiece 110 is a hearing device, for example a behind-the-ear hearing aid, a receiver-in-canal hearing aid, a cochlear implant plus hearing aid device, an in-the-canal hearing aid, an invisible-in-canal hearing aid, over-the-ear headphones, a headset with an external microphone, or a pair of ear buds, e.g., AirPods, corded or wireless headphones, or any headphone that includes at least one speaker and one microphone, as described further below with reference to FIG. 7. In some embodiments, earpiece 110 is an augmented reality, virtual reality, or extended reality audio device with eye tracking capabilities. The actions and descriptions of FIG. 1A may be used with any other embodiment of this disclosure. In addition, the actions and descriptions described in relation to FIG. 1A may be done in suitable alternative orders or in parallel to further the purposes of this disclosure.

In some embodiments, at step 102, the control circuitry of earpiece 110, worn by user 112, receives audio data 116. Audio data 116 is one or more voices from one or more users 114. In some embodiments, at step 104, the control circuitry of earpiece 110 stores the received audio data 116 in memory 118. In some embodiments, memory 118 is a temporary memory that has a limited capacity. In some embodiments, the control circuitry of earpiece 110 identifies the number of the one or more users 114 and the ambient noise level of the environment that user 112 is present in. Based on the capacity of the memory, the number of users 114 present in the environment, and the ambient noise level of the environment, the control circuitry of earpiece 110 adjusts the parameters of the audio data being stored in the memory 118.

At step 106, the control circuitry of earpiece 110 receives an input 120 from user 112. In some implementations, the input 120 is one or more taps from user 112 on the physical surface of the earpiece. In some implementations, the input 120 is a gesture from user 112, e.g., user 112 nodding their head. In some implementations, the input 120 is user 112 vocally expressing a desire to have one or more portions received audio data 116 be repeated, e.g., “What did they just say?”

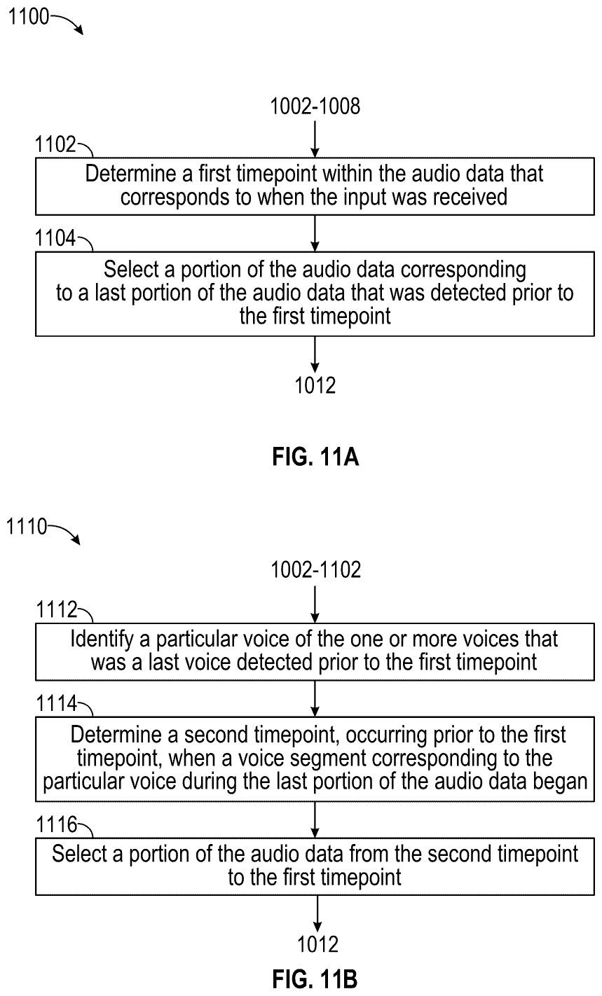

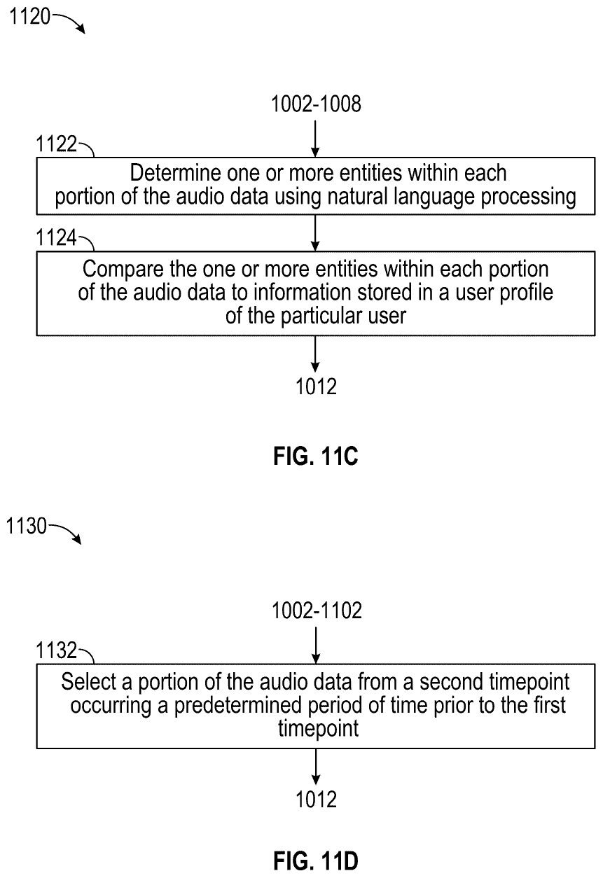

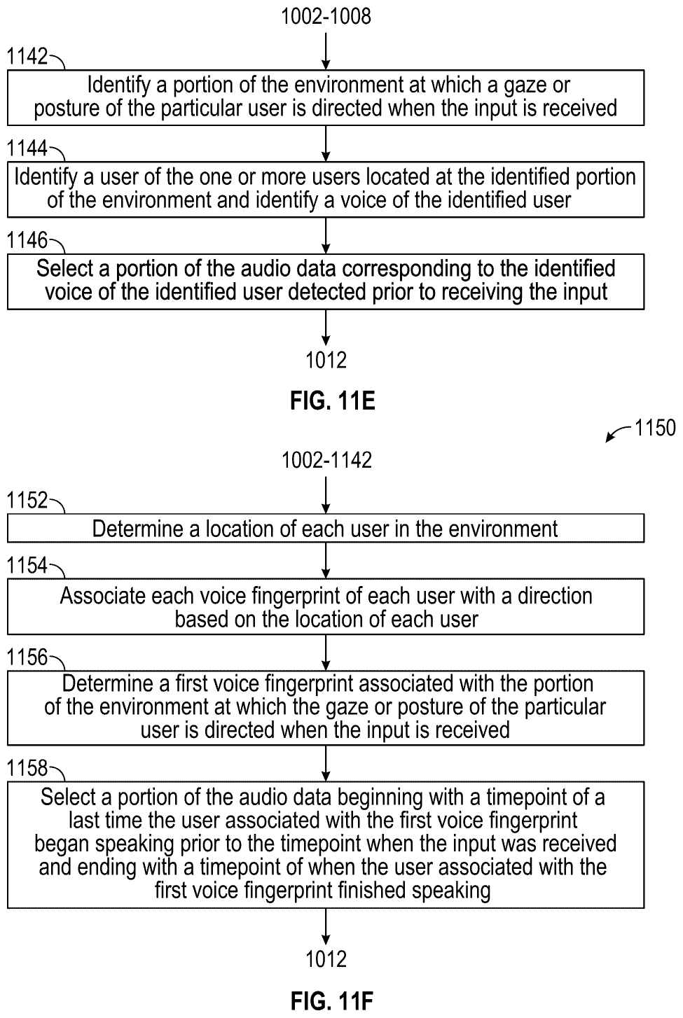

At step 108, the control circuitry of earpiece 110 selects a portion 122 of the audio data 116 to replay to user 112. In some examples, the control circuitry of earpiece 110 selects the portion 122 corresponding to the last portion of the audio data that was detected prior to the first timepoint within audio data 116 that the input 120 was received, as described further below with reference to FIG. 11A.

In some examples, the control circuitry of earpiece 110 selects the portion 122 from a second timepoint (the timepoint when the last user of users 114 to speak before the input 120 began speaking) to a first timepoint (the timepoint within audio data 116 at which the input 120 was received), as described further below with reference to FIG. 11B.

In some examples, the control circuitry of earpiece 110 selects the portion 122 based on comparing audio data 116 to user profile information for user 112, as described further below with reference to FIG. 11C.

In some examples, the control circuitry of earpiece 110 selects the portion 122 from a second timepoint occurring at a predetermined time period before the first timepoint when the input 120 was received, as described further below with reference to FIG. 11D.

In some examples, the control circuitry of earpiece 110 selects the portion 122 based on an estimated direction of the gaze of user 112 (derived from the head pose of user 112) and the location of users 114 in the environment that user 112 is present in, as described further below with reference to FIG. 11E and FIG. 11F. In some embodiments, the earpiece 110 is an augmented reality, virtual reality, or extended reality audio device with eye tracking capabilities, and the estimated direction of the gaze of user 112 is based on the eye movement of user 112.

At 109, the control circuitry of earpiece 110 causes the selected portion 122 of the audio data 116 to be replayed by earpiece 110 to user 112. For example, if the selected portion 122 is a voice saying, “I want coffee with cream,” the control circuitry of earpiece 110 will play back the recording of the voice saying, “I want coffee with cream” in the earpiece 110 being worn by user 112. In some embodiments, the control circuitry of earpiece 110 alters the portion 122 of audio data 116 before replaying it in earpiece 110 to user 112, by, for example, removing background noise, translating the portion 122 into another language, or changing a speed of the replay so it's faster or slower than the original recorded portion 122.

FIG. 1B is an illustrative example of a system for providing devices with audio replay capabilities, in accordance with some embodiments of the present disclosure. In some embodiments, system 130 includes earpiece 110, mobile device 132, and mobile device memory 138. System 130 may include additional servers, devices, and/or networks. In some examples, the steps outlined within system 130 are performed by the control circuitry of earpiece 110. The actions and descriptions of FIG. 1B may be used with any other embodiment of this disclosure. In addition, the actions and descriptions described in relation to FIG. 1B may be done in suitable alternative orders or in parallel to further the purposes of this disclosure.

In some embodiments, at step 102, the control circuitry of earpiece 110, worn by user 112, receives audio data 116. Audio data 116 is one or more voices from one or more users 114. At step 144, the control circuitry of earpiece 110 stores the received audio data 116 in mobile device memory 138 of mobile device 132. In some embodiments, earpiece 110 stores the captured audio portions in mobile device memory 138 into a combination of indexes representing a speaker and a portion of their speech. At step 146, the control circuitry of earpiece 110 receives an input 121 from user 112 at mobile device 132.

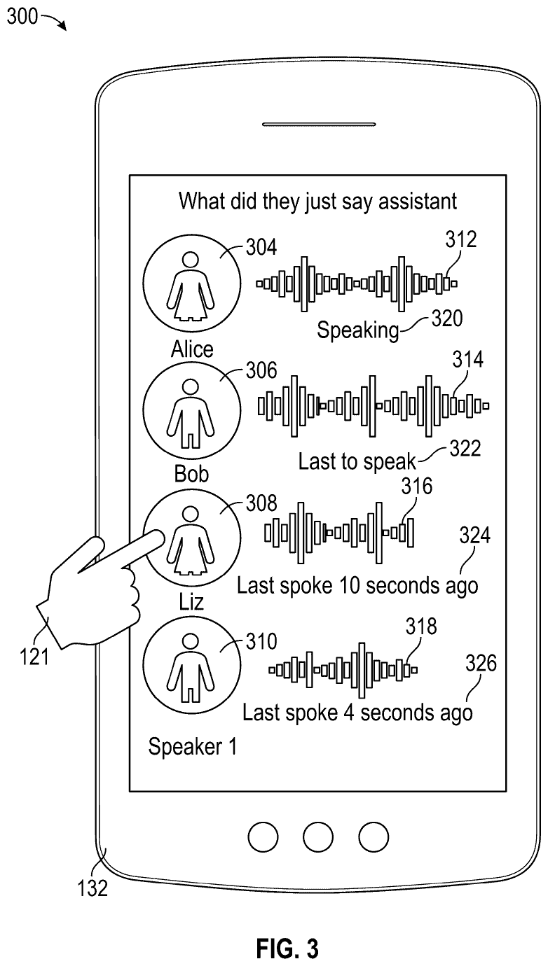

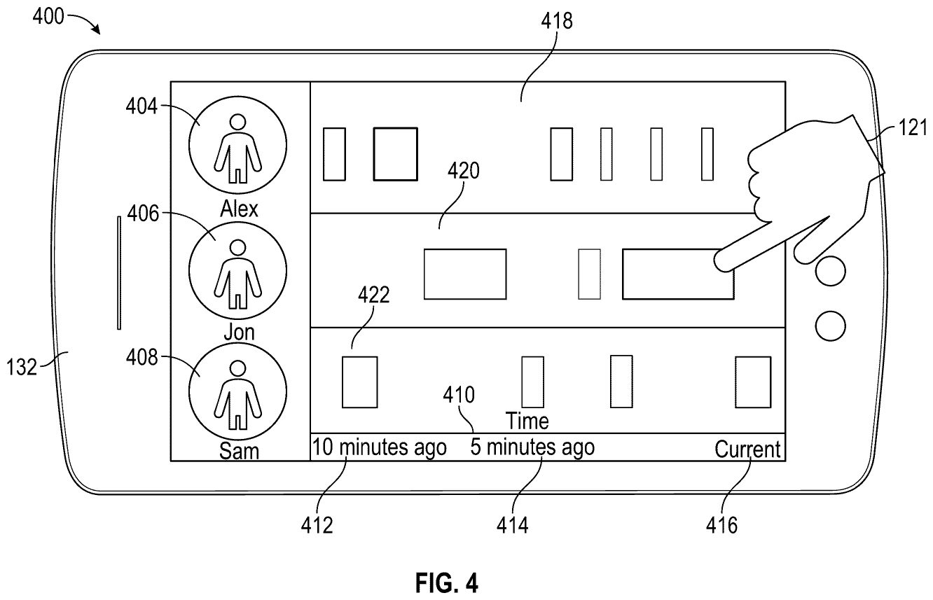

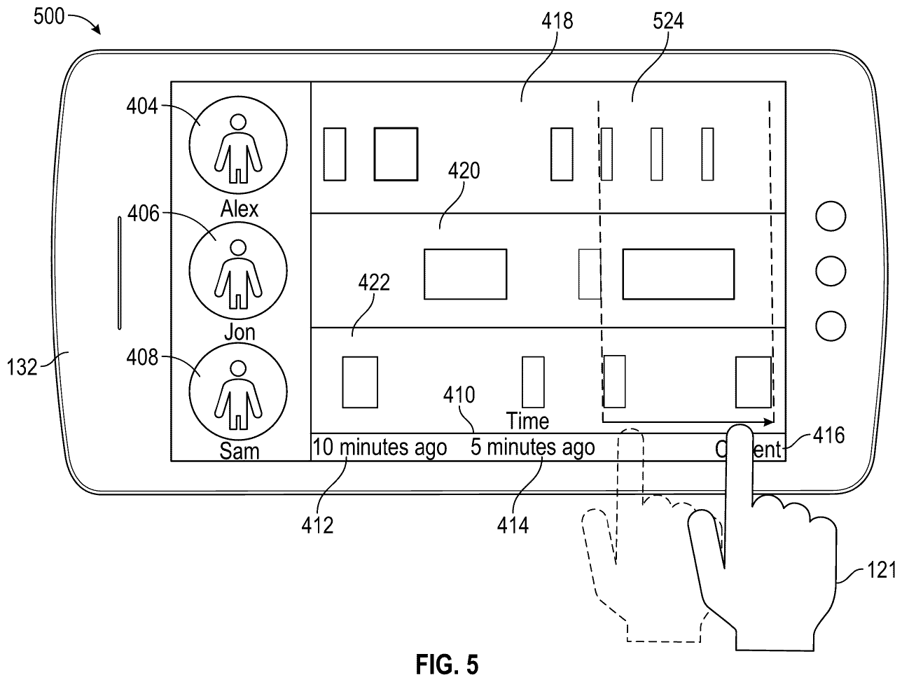

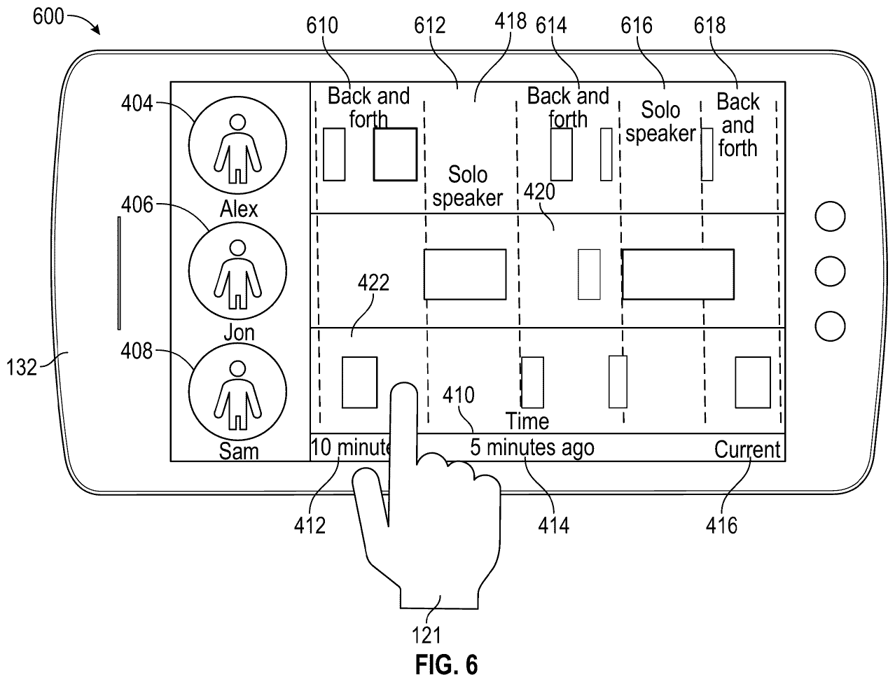

In some examples, input 121 is a user selection of an icon representing a user of users 114 on the user interface of mobile device 132, as described further below with reference to FIG. 3. In some examples, input 121 is a user selection of a portion on a timeline on the user interface of mobile device 132, as described further below with reference to FIG. 4, FIG. 5, and FIG. 6. In some examples, earpiece 110 receives input 121 from user 112 at earpiece 110, on a user interface of earpiece 110, and transfers the input signal to mobile device 132 to generate the portion of the stored audio data for replay.

At step 148, the control circuitry of earpiece 110 selects a portion 122 of audio data 116 to replay. In some examples, the control circuitry of earpiece 110 selects the portion 122 based on input 121 being a user selection of an icon representing a user of users 114 on the user interface of mobile device 132, as described further below with reference to FIG. 3. In some examples, the control circuitry of earpiece 110 selects the portion 122 based on input 121 being a user selection of a portion on a timeline on the user interface of mobile device 132, as described further below with reference to FIG. 4, FIG. 5, and FIG. 6.

At step 150, the control circuitry of earpiece 110 causes, by the mobile device, the selected portion 122 of the audio data 116 to be replayed by earpiece 110 worn by user 112.

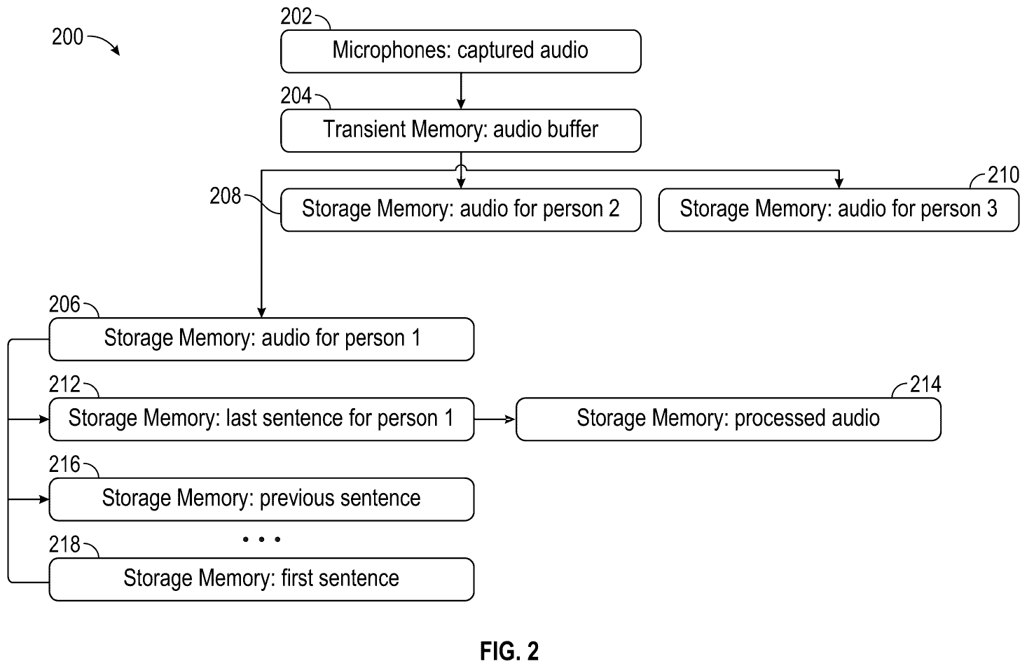

FIG. 2 is an illustrative example of a hierarchy of audio segments, in accordance with some embodiments of the present disclosure. In some embodiments, at 202, microphones, e.g., microphones of earpiece 110 of FIG. 1A, capture audio, e.g., audio data 116 of FIG. 1A. At 204, the captured audio is stored as an audio buffer in transient memory of, e.g., memory 118 of FIG. 1A, or mobile device memory 138 of FIG. 1B. In some embodiments, the captured audio is then divided into audio for each person detected within the audio and separately stored. At 206, audio for a first person is stored in storage memory of, e.g., memory 118 of FIG. 1A, or mobile device memory 138 of FIG. 1B, at 208, audio for a second person is stored in storage memory of, e.g., memory 118 of FIG. 1A, or mobile device memory 138 of FIG. 1B. At 210, audio for a third person is stored in storage memory of, e.g., memory 118 of FIG. 1A, or mobile device memory 138 of FIG. 1B. At 212, the last sentence spoken for the first person is stored in storage memory, and at 214, the last sentence spoken is stored in storage memory as processed audio, e.g., with background noise removed, with the last sentence translated into another language, or with the speed of the speech changed. At 216, the sentence immediately preceding the last sentence spoken for the first person is stored in storage memory. As indicated by the ellipsis, all sentences spoken by the first person are stored in storage memory, including, at 218, the first sentence spoken by the first person.

FIG. 3 is an illustrative example of an interface for the selection of audio segments for playback based on a selected user, in accordance with some embodiments of the present disclosure. In some embodiments, system 300 includes mobile device 132, input 121, Alice avatar 304, Bob avatar 306, Liz avatar 308, Speaker 1 avatar 310, Alice audio data 312, Bob audio data 314, Liz audio data 316, Speaker 1 audio data 318, Alice speaking status indicator 320, Bob speaking status indicator 322, Liz speaking status indicator 324, and Speaker 1 speaking status indicator 326. System 300 may include additional servers, devices, and/or networks.

In some embodiments, mobile device 132 displays an interface showing various detected speakers as avatars, e.g., Alice avatar 304, Bob avatar 306, Liz avatar 308, and Speaker 1 avatar 310 and the selection of an audio segment for playback is based on which avatar is selected by the user wearing the earpiece, e.g., earpiece 110 of FIG. 1B, through input 121. In some embodiments, Alice, Bob, and Liz have voice fingerprints already stored for them in the memory of mobile device 132, e.g., mobile device memory 138 of FIG. 1B, but Speaker 1 is a new speaker that the earpiece has not detected before and therefore does not have stored under any name and profile. In some embodiments, according to Alice speaking status indicator 320, Alice is currently speaking. In some embodiments, according to Bob speaking status indicator 322, Bob was the last to speak. In some embodiments, according to Liz speaking status indicator 324, Liz last spoke 10 seconds ago. In some embodiments, according to Speaker 1 speaking status indicator 326, Speaker 1 last spoke four seconds ago. In some embodiments, mobile device 132 receives input 121 to select Liz avatar 308 to hear Liz audio data 316, the audio data last spoken by Liz 10 seconds ago, as the audio data to replay into the earpiece. In some embodiments, the mobile device enables the user wearing the earpiece to associate a voice fingerprint detected by the earpiece with one of the contacts stored in the mobile device, allowing the interface to display an identifier including the contact's picture and contact's name. In some embodiments, the earpiece interface is connected to a telephone or voice messaging application on the mobile device; the earpiece associates a voice fingerprint with a contact's information based on previous conversations using the using the telephone or voice messaging applications and auto-populates the contacts' names and pictures without the user having to enter them.

FIG. 4 is an illustrative example of an interface for the selection of audio segments for playback based on a point on a timeline, in accordance with some embodiments of the present disclosure. In some embodiments, system 400 includes mobile device 132, input 121, Alex avatar 404, Jon avatar 406, Sam avatar 408, timeline 410, 10 minutes ago timeline indicator 412, 5 minutes ago timeline indicator 414, current timeline indicator 416, Alex audio data 418, Jon audio data 420, and Sam audio data 422. System 400 may include additional servers, devices, and/or networks.

In some embodiments, mobile device 132 displays an interface showing various detected speakers as avatars, e.g., Alex avatar 404, Jon avatar 406, and Sam avatar 408, associated with their detected voice fingerprints and the selection of an audio segment for playback is based on whether audio data for a particular avatar is selected by the user wearing the earpiece, e.g., earpiece 110 of FIG. 1B, through input 121. In some embodiments, Alex audio data 418, Jon audio data 420, and Sam audio data 422 are shown on timeline 410 as blocks indicating when on timeline 410 each person was speaking. In some embodiments, mobile device 132 receives input 121 to select the portion of Jon audio data 420 that is closest to the current timeline indicator 416 as the audio data to replay into the earpiece.

FIG. 5 is an illustrative example of an interface for the selection of audio segments for playback based on a time range on a timeline, in accordance with some embodiments of the present disclosure. In some embodiments, system 500 includes mobile device 132, input 121, Alex avatar 404, Jon avatar 406, Sam avatar 408, timeline 410, 10 minutes ago timeline indicator 412, 5 minutes ago timeline indicator 414, current timeline indicator 416, Alex audio data 418, Jon audio data 420, Sam audio data 422, and desired time range for playback 524. System 500 may include additional servers, devices, and/or networks.

In some embodiments, mobile device 132 displays the interface described above, with reference to FIG. 5. In some embodiments, mobile device 132 receives input 121 to select desired time range for playback 524 as the portion of audio data to replay. In this example, the audio from all speakers (Alex, Jon, and Sam) that was recorded from 5 minutes ago until the current time will be replayed.

FIG. 6 is an illustrative example of an interface for the selection of audio segments for playback based on specific time periods on a timeline, in accordance with some embodiments of the present disclosure. In some embodiments, system 600 includes mobile device 132, input 121, Alex avatar 404, Jon avatar 406, Sam avatar 408, timeline 410, 10 minutes ago timeline indicator 412, 5 minutes ago timeline indicator 414, current timeline indicator 416, Alex audio data 418, Jon audio data 420, Sam audio data 422, first back-and-forth section 610, first solo speaker section 612, second back-and-forth section 614, second solo speaker section 616, and third back-and-forth section 618. System 600 may include additional servers, devices, and/or networks.

In some embodiments, mobile device 132 displays the interface described above, with reference to FIG. 5, with section divisions to indicate when one speaker was present within audio data for a period of time and when more than one speaker were discussing back and forth within the audio data for a period of time. In some embodiments, mobile device 132 receives input 121 to select first back-and-forth section 610 as the portion of the audio data to replay.

FIG. 7 is a shows illustrative examples of devices with audio replay capabilities, in accordance with some embodiments of the present disclosure. In some embodiments, system 700 includes earpieces 702-718. Earpiece 702 is an illustrative example of a behind-the-ear hearing aid. Earpiece 704 is an illustrative example of a receiver-in-canal hearing aid. Earpiece 706 is an illustrative example of a cochlear implant plus hearing aid device. Earpiece 708 is an illustrative example of an in-the-canal hearing aid. Earpiece 710 is an illustrative example of an invisible-in-canal hearing aid. Earpiece 712 is an illustrative example of a set of over-the-ear headphones. Earpiece 714 is an illustrative example of a headset with an external microphone. Earpiece 716 is an illustrative example of a set of AirPods. Earpiece 718 is an illustrative example of a set of corded headphones.

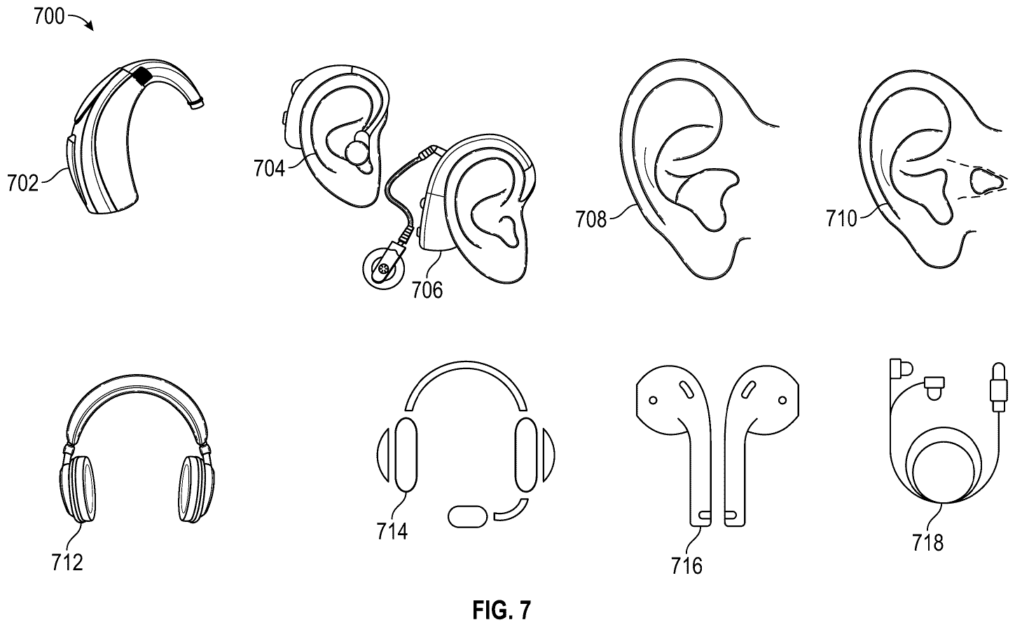

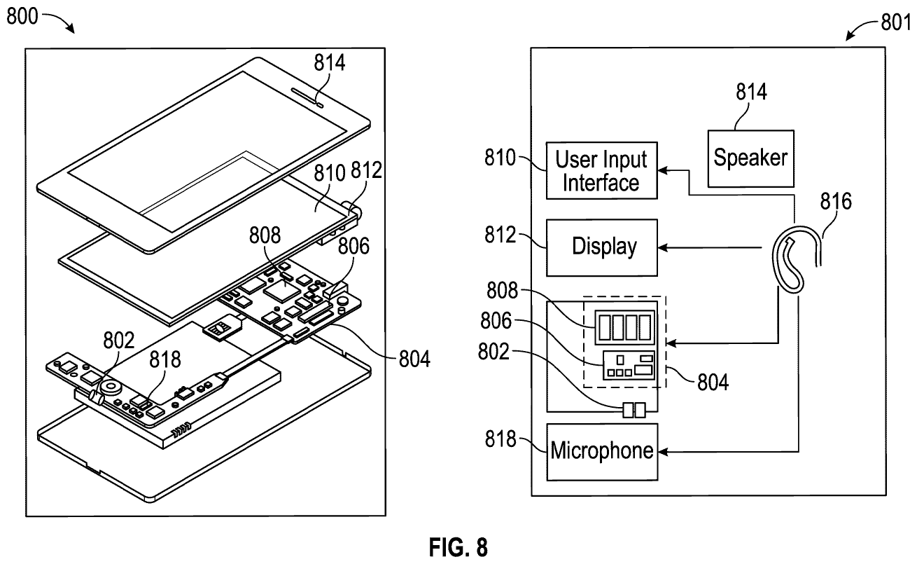

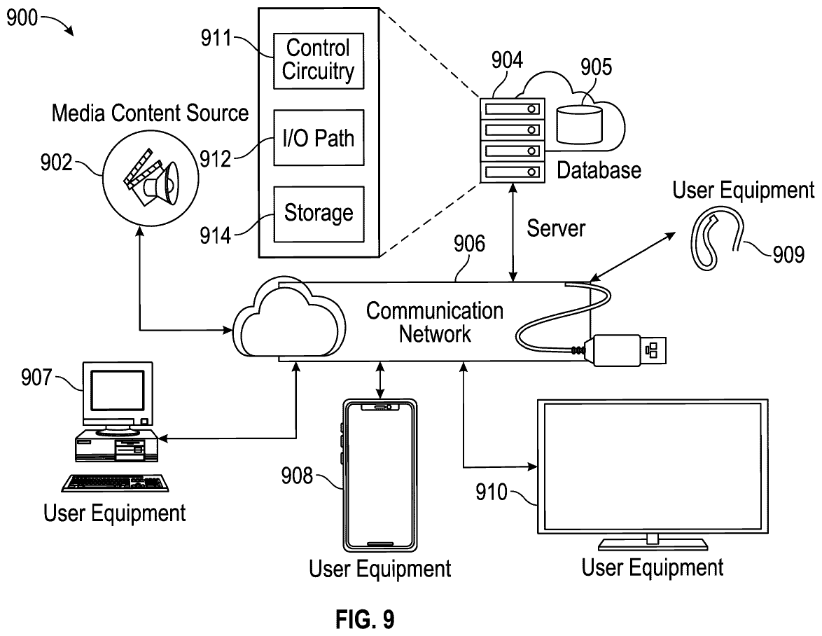

FIGS. 8 and 9 describe exemplary devices, systems, servers, and related hardware for an advanced teleprompter with dynamic content management, in accordance with some embodiments of the present disclosure. FIG. 8 shows generalized embodiments of illustrative devices 800 and 801. For example, devices 800 and 801 may be smartphone devices, laptops, televisions (e.g., mobile device 132 of FIG. 1B), smart televisions, streaming sticks, smart speakers, hearing devices (e.g., any one of devices 702-718 of FIG. 7) or voice assistants. Device 801 may include earpiece 816. Earpiece 816 may be communicatively connected to microphone 818, speakers 814, and display 812. In some embodiments, microphone 818 may receive voice commands. In some embodiments, display 812 may be an optional display on the earpiece 816. In some embodiments, earpiece 816 may be communicatively connected to user input interface 810. In some embodiments, user input interface 810 may be a remote-control device. Earpiece 816 may include one or more circuit boards. In some embodiments, the circuit boards may include processing circuitry, control circuitry, and storage (e.g., RAM, ROM, Hard Disk, Removable Disk, etc.). In some embodiments, the circuit boards may include an input/output path. More specific implementations of devices are discussed below in connection with FIG. 8. Each one of devices 800 and 801 may receive data via input/output (“I/O”) path 802. I/O path 802 may provide data to control circuitry 804, which includes processing circuitry 806 and storage 608. Control circuitry 804 may be used to send and receive commands, requests, and other suitable data using I/O path 802, which may comprise I/O circuitry. I/O path 802 may connect control circuitry 804 (and specifically processing circuitry 606) to one or more communications paths (described below). I/O functions may be provided by one or more of these communications paths but are shown as a single path in FIG. 8 to avoid overcomplicating the drawing.

Control circuitry 804 may be based on any suitable processing circuitry such as processing circuitry 806. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 804 executes instructions for an audio replay application stored in memory (i.e., storage 808). Specifically, control circuitry 804 may be instructed by the audio replay application to perform the functions discussed above and below. In some implementations, any action performed by control circuitry 804 may be based on instructions received from the audio replay application.

In client/server-based embodiments, control circuitry 804 may include communications circuitry suitable for communicating with networks or servers. The instructions for carrying out the above-mentioned functionality may be stored on a server (which is described in more detail in connection with FIG. 8). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the internet or any other suitable communication networks or paths (which is described in more detail in connection with FIG. 8). In addition, communications circuitry may include circuitry that enables peer-to-peer communication of devices, or communication of devices in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, recorders, solid state devices, quantum storage devices, or any other suitable fixed or removable storage devices, and/or any combination of the same. Storage 808 may be used to store various types of content described herein as well as data described above. Nonvolatile memory may also be used (e.g., to launch a boot-up routine and other instructions). Cloud-based storage, described in relation to FIG. 8, may be used to supplement storage 808 or instead of storage 808.

Control circuitry 804 may also include scaler circuitry for upconverting and downconverting content into the preferred output format of device 800. Circuitry 804 may also include digital-to-analog converter circuitry and analog-to-digital converter circuitry for converting between digital and analog signals. The circuitry described herein may be implemented using software running on one or more general purpose or specialized processors.

A user may send instructions to control circuitry 804 using user input interface 810. User input interface 810 may be any suitable user interface, such as a remote control, mouse, trackball, keypad, keyboard, touch screen, touchpad, stylus input, joystick, voice recognition interface, or other user input interfaces. In some embodiments, user input interface 810 is composed of capacitive touch technology, resistive touch technology, or proximity sensors. Display 812 may be provided as a stand-alone device or integrated with other elements of each one of device 800 and device 801. For example, display 812 may be a touchscreen or touch-sensitive display. In such circumstances, user input interface 810 may be integrated with or combined with display 812. Display 812 may be one or more of a monitor, a television, a display for a mobile device, or any other type of display. A video card or graphics card may generate the output to display 812. The video card may be any processing circuitry described above in relation to control circuitry 804. The video card may be integrated with the control circuitry 804. Speakers 814 may be provided as integrated with other elements of each one of device 800 and device 801 or may be stand-alone units. The audio component of videos and other content displayed on display 812 may be played through the speakers 814. In some embodiments, the audio may be distributed to a receiver (not shown), which processes and outputs the audio via speakers 814.

The audio replay application may be implemented using any suitable architecture. For example, it may be a stand-alone application wholly implemented on each one of device 800 and device 801. In such an approach, instructions of the audio replay application are stored locally (e.g., in storage 808), and data for use by the audio replay application is downloaded on a periodic basis (e.g., from an out-of-band feed, from an internet resource, or using another suitable approach). Control circuitry 804 may retrieve instructions of the audio replay application from storage 808 and process the instructions to rearrange the segments as discussed. Based on the processed instructions, control circuitry 804 may determine what action to perform when input is received from user input interface 810. For example, movement of a cursor on a display up/down may be indicated by the processed instructions when user input interface 810 indicates that an up/down button was selected.

In some embodiments, the audio replay application is a client/server-based application. Data for use by a thick or thin client implemented on each one of device 800 and device 801 is retrieved on-demand by issuing requests to a server remote to each one of device 800 and device 801. In one example of a client/server-based guidance application, control circuitry 804 runs a web browser that interprets web pages provided by a remote server. For example, the remote server may store the instructions for the audio replay application in a storage device. The remote server may process the stored instructions using circuitry (e.g., control circuitry 804) to perform the operations discussed in connection with FIGS. 1-7 and 10-17.

In some embodiments, the audio replay application may be downloaded and interpreted or otherwise run by an interpreter or virtual machine (run by control circuitry 804). In some embodiments, the audio replay application may be encoded in the ETV Binary Interchange Format (EBIF), received by the control circuitry 804 as part of a suitable feed, and interpreted by a user agent running on control circuitry 804. For example, the audio replay application may be an EBIF application. In some embodiments, the audio replay application may be defined by a series of JAVA-based files that are received and run by a local virtual machine or other suitable middleware executed by control circuitry 804. In some of such embodiments (e.g., those employing MPEG-2 or other digital media encoding schemes), the audio replay application may be, for example, encoded and transmitted in an MPEG-2 object carousel with the MPEG audio and video packets of a program.

FIG. 9 is a diagram of an illustrative audio replay system, in accordance with some embodiments of the disclosure. Devices 907, 908, 910 (e.g., mobile device 132 of FIG. 1B, which may be a smartphone device, laptop, television, smart television streaming stick, smart speaker or voice assistant) and earpiece 909 may be coupled to communication network 906. Communication network 906 may be one or more networks including the internet, a mobile phone network, mobile voice or data network (e.g., a 4G or LTE network), cable network, public switched telephone network, or other types of communication network or combinations of communication networks. Paths (e.g., depicted as arrows connecting the respective devices to the communication network 906) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 9 to avoid overcomplicating the drawing.

Although communications paths are not drawn between devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The devices may also communicate with each other directly through an indirect path via communication network 906.

System 900 includes a media content source 902 and a server 904, which may comprise or be associated with database 905. Communications with media content source 902 and server 904 may be exchanged over one or more communications paths but are shown as a single path in FIG. 9 to avoid overcomplicating the drawing. In addition, there may be more than one of each of media content source 902 and server 904, but only one of each is shown in FIG. 9 to avoid overcomplicating the drawing. If desired, media content source 902 and server 904 may be integrated as one source device.

In some examples, the processes outlined within system 900 are performed by earpiece 909. In some embodiments, server 904 may include control circuitry 911 and a storage 914 (e.g., RAM, ROM, Hard Disk, Removable Disk, etc.). In some embodiments, storage 914 may store instructions that when, executed by control circuitry 911, may cause control circuitry 911 to execute the steps outlined within system 900. Server 904 may also include an input/output path 912. I/O path 912 may provide device information, or other data, over a local area network (LAN) or wide area network (WAN), and/or other content and data to the control circuitry 911, which includes processing circuitry, and storage 914. The control circuitry 911 may be used to send and receive commands, requests, and other suitable data using I/O path 912, which may comprise I/O circuitry. I/O path 912 may connect control circuitry 911 (and specifically processing circuitry) to one or more communications paths.

Control circuitry 911 may be based on any suitable processing circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 911 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, the control circuitry 911 executes instructions for an emulation system application stored in memory (e.g., the storage 914). Memory may be an electronic storage device provided as storage 914 that is part of control circuitry 911.

Server 904 may retrieve guidance data from media content source 902, process the data as will be described in detail below, and forward the data to devices 907 and 910. Media content source 902 may include one or more types of content distribution equipment including a television distribution facility, cable system headend, satellite distribution facility, programming sources (e.g., television broadcasters, such as NBC, ABC, HBO, etc.), intermediate distribution facilities and/or servers, internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Media content source 902 may be the originator of content (e.g., a television broadcaster, a Webcast provider, etc.) or may not be the originator of content (e.g., an on-demand content provider, an internet provider of content of broadcast programs for downloading, etc.). Media content source 902 may include cable sources, satellite providers, on-demand providers, internet providers, over-the-top content providers, or other providers of content. Media content source 902 may also include a remote media server used to store different types of content (including video content selected by a user), in a location remote from any of the client devices. Media content source 902 may also provide metadata that can be used to identify important segments of media content as described above. Earpiece 909 may also be the originator of data (e.g., recorded conversations).

Client devices may operate in a cloud computing environment to access cloud services. In a cloud computing environment, various types of computing services for content sharing, storage or distribution are provided by a collection of network-accessible computing and storage resources, referred to as “the cloud.” For example, the cloud can include a collection of server computing devices (such as, e.g., server 904), which may be located centrally or at distributed locations, that provide cloud-based services to various types of users and devices connected via a network such as the internet via communication network 906. In such embodiments, devices may operate in a peer-to-peer manner without communicating with a central server.

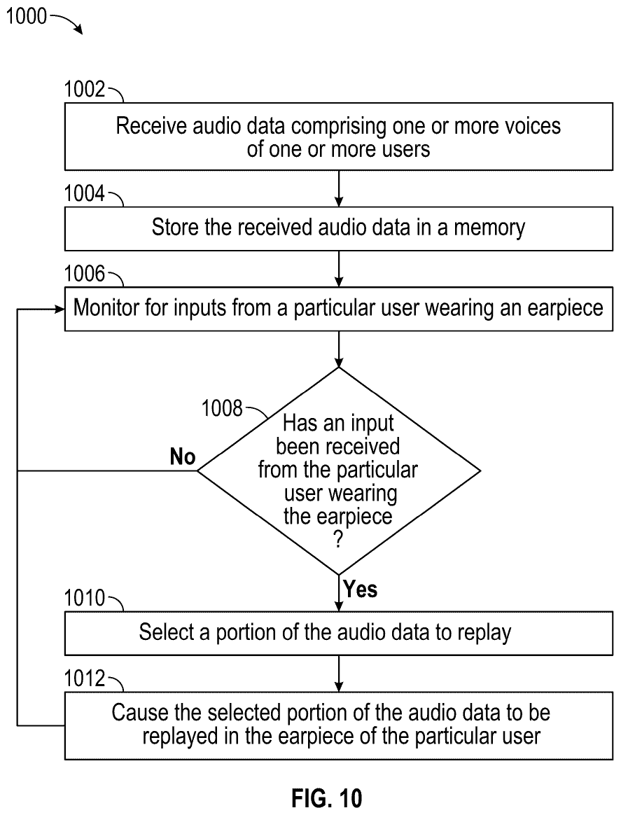

FIG. 10 is a flowchart of an illustrative process for providing devices with audio replay capabilities, in accordance with some embodiments of the present disclosure. In various embodiments, the individual steps of process 1000 may be implemented by the control circuitry of earpiece 110 of FIG. 1A. For example, non-transitory memories of one or more components of earpiece 110 and devices of FIGS. 8 and 9, e.g., storage 914 and control circuitry 911, may store instructions that, when executed by the control circuitry of the earpiece and devices of FIGS. 8 and 9 (as described further above with reference to FIGS. 8 and 9), cause execution of the process depicted in FIG. 10. The actions or descriptions of FIG. 10 may be used with any other embodiment of this disclosure. In addition, the actions and descriptions described in relation to FIG. 10 may be done in suitable alternative orders or in parallel to further the purposes of this disclosure.

In some embodiments, at 1002, control circuitry, for example, control circuitry 911 of FIG. 9, or control circuitry of earpiece 110 of FIG. 1A, receives audio data, e.g., audio data 116 of FIG. 1A, with one or more voices of one or more users. At 1004, control circuitry stores the received audio data in a memory, e.g., memory 118 of FIG. 1A, mobile device memory 138 of FIG. 1B, storage 808 of FIG. 8, or storage 914 of FIG. 9. At 1006, control circuitry monitors for inputs, e.g., input 120 of FIG. 1A, or input 121 of FIG. 1B, from a user, e.g., user 112 of FIG. 1A, wearing an earpiece, e.g., earpiece 110 of FIG. 1A. At 1008, control circuitry determines whether an input has been received from the user wearing the earpiece. If the control circuitry determines at 1008 that an input has not been received, process 1000 returns to 1006 and continues monitoring for inputs from the user wearing the earpiece. If the control circuitry determines at 1008 that an input has been received, process 1000 proceeds to 1010. At 1010, control circuitry selects a portion of the audio data to replay, as described further below with reference to FIGS. 11A, FIG. 11B, FIG. 11C, FIG. 11D, FIG. 11E, and FIG. 11F. At 1012, control circuitry causes the selected portion of the audio data to be replayed by the earpiece for the user wearing the earpiece. In some embodiments, process 1000 then returns to 1006 and continues to monitor for inputs from the user wearing the earpiece.

FIG. 11A is a flowchart of an illustrative process for providing devices with audio replay capabilities, in accordance with some embodiments of the present disclosure. In various embodiments, the individual steps of process 1100 may be implemented by the control circuitry of earpiece 110 of FIG. 1A. For example, non-transitory memories of one or more components of earpiece 110 and devices of FIGS. 8 and 9, e.g., storage 914 and control circuitry 911, may store instructions that, when executed by the control circuitry of the earpiece and devices of FIGS. 8 and 9 (as described further above with reference to FIGS. 8 and 9), cause execution of the process depicted in FIG. 11A. The actions or descriptions of FIG. 11A may be used with any other embodiment of this disclosure. In addition, the actions and descriptions described in relation to FIG. 11A may be done in suitable alternative orders or in parallel to further the purposes of this disclosure.

In some embodiments, following the actions outlined in process step 1008 in FIG. 10, at step 1102, control circuitry determines a first timepoint within the audio data that corresponds to when the input was received. At step 1104, control circuitry selects a portion of the audio data corresponding to a last portion of the audio data that was detected prior to the first timepoint. In some embodiments, the last portion is selected because the user wearing the earpiece indicated with the input that they wanted the last thing that was said to be repeated. For example, the user wearing the earpiece said “Repeat that last part” as the input.

FIG. 11B is a flowchart of an illustrative process for providing devices with audio replay capabilities, in accordance with some embodiments of the present disclosure. In various embodiments, the individual steps of process 1110 may be implemented by the control circuitry of earpiece 110 of FIG. 1A. For example, non-transitory memories of one or more components of earpiece 110 and devices of FIGS. 8 and 9, e.g., storage 914 and control circuitry 911, may store instructions that, when executed by the control circuitry of the earpiece and devices of FIGS. 8 and 9 (as described further above with reference to FIGS. 8 and 9), cause execution of the process depicted in FIG. 11B. The actions or descriptions of FIG. 11B may be used with any other embodiment of this disclosure. In addition, the actions and descriptions described in relation to FIG. 11B may be done in suitable alternative orders or in parallel to further the purposes of this disclosure.

In some embodiments, following the actions outlined in process step 1102 in FIG. 11A, at step 1112, control circuitry identifies a particular voice of the one or more voices that was a last voice detected prior to the first timepoint. In some embodiments, control circuitry differentiates voices based on calibration, sound level, or spectrum measurement. At step 1114, control circuitry determines a second timepoint, occurring prior to the first timepoint, when a voice segment corresponding to the particular voice during the last portion of the audio data began. In some embodiments, the last portion is selected because the user wearing the earpiece indicated with the input that they wanted the last thing a certain person just said to be repeated. For example, the user wearing the earpiece said, “What did they just say?” as the input.

FIG. 11C is a flowchart of an illustrative process for providing devices with audio replay capabilities, in accordance with some embodiments of the present disclosure. In various embodiments, the individual steps of process 1120 may be implemented by the control circuitry of earpiece 110 of FIG. 1A. For example, non-transitory memories of one or more components of earpiece 110 and devices of FIGS. 8 and 9, e.g., storage 914 and control circuitry 911, may store instructions that, when executed by the control circuitry of the earpiece and devices of FIGS. 8 and 9 (as described further above with reference to FIGS. 8 and 9), cause execution of the process depicted in FIG. 11C. The actions or descriptions of FIG. 11C may be used with any other embodiment of this disclosure. In addition, the actions and descriptions described in relation to FIG. 11C may be done in suitable alternative orders or in parallel to further the purposes of this disclosure.

In some embodiments, following the actions outlined in process step 1008 in FIG. 10, at step 1122, control circuitry determines one or more entities within each portion of the audio data using natural language processing. In some embodiments, the control circuitry executes the natural language processing through a machine learning model that has been trained on a training set of audio data with words spoken by users. In some embodiments, audio data is the input to the machine learning model, and potential entities determined from the audio data are the outputs of the machine learning model. The control circuitry determines the one or more entities by, for example, identifying the entities “college,” “sports,” “college sports,” “basketball,” “college basketball,” “Iowa,” and “Caitlin Clark” after processing a portion of the audio data that contains the words “I love college sports, especially basketball, Iowa's Caitlin Clark is so fun to watch.” At step 1124, control circuitry compares the one or more entities within each portion of the audio data to information stored in a user profile of the user wearing the earpiece. For example, control circuitry finds that the user profile has stored preferences for “college sports” and “basketball,” and because the user has interests in common with what was mentioned in the portion of the audio data, the control circuitry selects that portion of the audio data to replay.

In some embodiments, the machine learning model carries out other processing functions for the earpiece. In another example, the machine learning model analyzes the content of portions of audio data and computes a complexity score. The complexity score is based on, for example, one or more of the number of words contained in the portion to be repeated, the length of the portion, whether previous conversations involving the same people have led to a certain number of repeats, or the probability that the words in the portion will be misunderstood by the user wearing the earpiece based on their hearing capability or on historical data gathered during previous conversations (for instance, “caught” and “got” may be confusing to some people if their ears can't distinguish “k” and “g” when it is not loud enough). In some embodiments, the machine learning model weights more words spoken by the certain people as higher than words spoken by other people. In some embodiments, when the complexity score exceeds a predetermined threshold amount preconfigured by the user wearing the hearing device, the machine learning model summarizes the portion to be replayed using a large language model, converts the summarization using speech-to-text technology into a new audio portion, and plays back the new audio portion to the user wearing the hearing device. In some embodiments, voice fingerprints are used for the speech-to-text technology so the summarized audio portion is played in the voice of the person who spoke the original audio portion. In another example, the earpiece generates new audio portions highlighting important keywords of the original audio segments to be repeated or generates a new audio portion that only contains the words predicted to be the most confusing based on their pronunciation and the frequency response curve of the ear of the user wearing the earpiece. In another example, the machine learning model summarizes the portion to be repeated so it can be replayed in a shorter amount of time so not to disturb the ongoing conversation.

FIG. 11D is a flowchart of an illustrative process for providing devices with audio replay capabilities, in accordance with some embodiments of the present disclosure. In various embodiments, the individual steps of process 1130 may be implemented by the control circuitry of earpiece 110 of FIG. 1A. For example, non-transitory memories of one or more components of earpiece 110 and devices of FIGS. 8 and 9, e.g., storage 914 and control circuitry 911, may store instructions that, when executed by the control circuitry of the earpiece and devices of FIGS. 8 and 9 (as described further above with reference to FIGS. 8 and 9), cause execution of the process depicted in FIG. 11D. The actions or descriptions of FIG. 11D may be used with any other embodiment of this disclosure. In addition, the actions and descriptions described in relation to FIG. 11D may be done in suitable alternative orders or in parallel to further the purposes of this disclosure.

In some embodiments, following the actions outlined in process step 1102 in FIG. 11A, at step 1132, control circuitry selects a portion of the audio data from a second timepoint occurring at a predetermined period of time prior to the first timepoint, for example, 30 seconds prior to the first timepoint. In some embodiments, the predetermined period of time is set by the user wearing the earpiece on the user's mobile device, e.g., mobile device 132 of FIG. 1B. In some embodiments, the predetermined period of time is set by the user wearing the earpiece as part of the input, by, for example, the user saying, “Can you replay the last 30 seconds back to me?” into the earpiece.

FIG. 11E is a flowchart of an illustrative process for providing devices with audio replay capabilities, in accordance with some embodiments of the present disclosure. In various embodiments, the individual steps of process 1140 may be implemented by the control circuitry of earpiece 110 of FIG. 1A. For example, non-transitory memories of one or more components of earpiece 110 and devices of FIGS. 8 and 9, e.g., storage 914 and control circuitry 911, may store instructions that, when executed by the control circuitry of the earpiece and devices of FIGS. 8 and 9 (as described further above with reference to FIGS. 8 and 9), cause execution of the process depicted in FIG. 11E. The actions or descriptions of FIG. 11E may be used with any other embodiment of this disclosure. In addition, the actions and descriptions described in relation to FIG. 11E may be done in suitable alternative orders or in parallel to further the purposes of this disclosure.

In some embodiments, following the actions outlined in process step 1008 in FIG. 10, at step 1142, control circuitry identifies a portion of the environment based on an estimated direction of the gaze of the user wearing the earpiece (derived from the head pose of the user wearing the earpiece) when the input is received. In some embodiments, the earpiece is fitted with a head pose detection interface made of inertial measurement sensors, for example, accelerometers and gyrometers, as well as orientation sensors, tilt sensors, and magnetic field sensors. In some implementations, the earpiece is also fitted with or connected to an array of microphones allowing special localization of an audio source, for example, for the earpiece to associate voice fingerprints with source directions. In some examples, the earpiece keeps track of the directions of voice fingerprints as the source of each voice changes location relative to the user wearing the hearing device. For example, control circuitry estimates, based on the head pose of the user wearing the earpiece, that the user wearing the earpiece is looking over their left shoulder towards the left side of a couch within a room. At step 1144, control circuitry identifies a user of the one or more users present in the environment the user wearing the earpiece is in that is located at the identified portion of the environment and identifies the voice of the user of the one or more users. For example, control circuitry identifies a user sitting on the left side of the couch within the room and identifies their voice using calibration, sound level, a classifier model, or spectrum measurement. In some embodiments, the voice of the user of the one or more users is identified using the microphones implemented within the earpiece. At step 1146, control circuitry selects a portion of the audio data corresponding to the identified voice of the identified user detected prior to receiving the input. For example, control circuitry selects the last sentences spoken by the user sitting on the left side of the couch within the room prior to receiving the input from the user wearing the earpiece.

FIG. 11F is a flowchart of an illustrative process for providing devices with audio replay capabilities, in accordance with some embodiments of the present disclosure. In various embodiments, the individual steps of process 1140 may be implemented by the control circuitry of earpiece 110 of FIG. 1A. For example, non-transitory memories of one or more components of earpiece 110 and devices of FIGS. 8 and 9, e.g., storage 914 and control circuitry 911, may store instructions that, when executed by the control circuitry of the earpiece and devices of FIGS. 8 and 9 (as described further above with reference to FIGS. 8 and 9), cause execution of the process depicted in FIG. 11F. The actions or descriptions of FIG. 11F may be used with any other embodiment of this disclosure. In addition, the actions and descriptions described in relation to FIG. 11F may be done in suitable alternative orders or in parallel to further the purposes of this disclosure.

In some embodiments, following the actions outlined in process step 1142 in FIG. 11E, at step 1152, control circuitry determines a location of each user in the environment. For example, control circuitry determines that a first user is sitting on the left side of a couch, a second user is sitting on the right side of the couch, and a third user is sitting on a chair across from the couch. At step 1154, control circuitry associates each voice fingerprint of each user with a direction based on the location of each user. In some embodiments, control circuitry differentiates voices based on calibration, sound level, or spectrum measurement. At step 1156, control circuitry determines a first voice fingerprint associated with the portion of the environment based on an estimated gaze (derived from the head pose of the user wearing the earpiece) of the user wearing the earpiece when the input is received. For example, control circuitry identifies that the user is looking over their left shoulder towards the left side of a couch within a room and determines a first voice fingerprint that matches the user sitting on the left side of the couch. In some embodiments, control circuitry extracts distinct speaker voice profiles from the audio data captured by the microphones and upon detecting that a portion of a captured audio stream matches that of a voice profile, saves it in different indexes into the storage memory. At step 1158, control circuitry selects a portion of the audio data beginning with a timepoint of the last time the user associated with the first voice fingerprint began speaking prior to the timepoint when the input was received and ending with a timepoint of when the user associated with the first voice fingerprint finished speaking. For example, control circuitry selects the last sentence spoken by the user sitting on the left side of the couch within the room prior to receiving the input from the user wearing the earpiece. In some implementations, the earpiece generates a new audio portion made of the audio captured between the last recorded timestamp in storage memory and the time the earpiece detected an activation contact gesture, identifies voice fingerprints for the voices within the portion, locates the last recorded audio portions that match the voice direction of the user head pose and plays these audio portions back to the user wearing the hearing device. In another example, playback of the audio portion is directional, for example, the earpiece recreates the direction from which the portion of audio being replayed was originally captured during playback. In another example, the hearing device may detect that the speaker of the audio portion to replay has now moved to a new position since the audio portion was recorded and the earpiece may replay the audio portion simulating the new direction. In another example, the earpiece may automatically update its directional metadata in the storage memory upon detecting that a speaker previously fingerprinted at one location has now moved to a new location.

In some embodiments, a connected mobile device, e.g., mobile device 132 of FIG. 1B, stores a collection of voice fingerprints for all people that the user wearing the earpiece has had conversations with, and the earpiece only stores a subset of that collection due to storage limitation. In some implementations, the earpiece operates in non-connected mode, as a standalone hearing aid based solely on the voice fingerprints it generates and stores locally. However, when the earpiece is connected to the mobile device, it synchronizes its voice fingerprint library with the mobile device. In some examples, upon reconnection, voice fingerprints of new voices stored on the earpiece are transferred to the mobile device.

In some examples, the mobile device attaches additional metadata, for example, how often a particular voice fingerprint is detected by the earpiece. In some embodiments, based on both the recurrence of a voice fingerprint and the propensity of that fingerprint to be repeated for the user, the mobile device ranks the voice fingerprints in its library and transfers the highest-ranking portion back to the earpiece for further use.

In some embodiments, the earpiece and mobile device synchronization may be triggered when the earpiece is detected moving away from the mobile device, such as measuring a signal strength between the earpiece and the mobile device that is trending below a pre-determined threshold. In another example, the voice fingerprints generated by the earpiece on-device may have a lower resolution than the voice fingerprints generated by the mobile device; the mobile device then generates a lower resolution version of the voice fingerprint before transferring it to the earpiece's embedded storage memory. In some examples, the smart device maintains a library of voice fingerprints that include both high- and low-resolution versions of the same voice fingerprint. In some embodiments, high and low-resolution may be interpreted as the level of quantization a voice discriminator would work with. For example, a smartphone may use a quantization of 16 or 32 bits to process voice samples and discriminate one from the other while an earpiece control circuitry would use 8, 4 or even 1 bit quantization. In some examples, the earpiece selectively adjusts the quantization of its voice discriminator based on how often it needs to repeat speech associated with a voice fingerprint.

In some embodiments, the location resource (such as GPS) of the connected mobile device may be used to group voice fingerprints by geographical use. In some implementations, the mobile device appends a set of geographical locations to the metadata for a voice fingerprint in its storage memory based on the various locations a voice fingerprint is detected at by the mobile device. Upon detecting that the mobile device and the earpiece are moving away from each other, the mobile device may select a subset of the voice fingerprints in its library to transfer to the earpiece based on the last location of the mobile device and the voice fingerprint more likely to be present at that location.

In some embodiments, the earpiece is connected to a media application and receives voice fingerprinting information from the media application when consuming a piece of media content. For example, a user watches a movie and uses the earpiece to repeat portions of a dialogue in that movie. In some embodiments, the earpiece may receive the location of a speaking character on the screen, derive an audio source location when that character speaks, and select the audio segment to be replayed based on that determination. In some examples, the earpiece is activated when a user is listening to a song and the earpiece circuitry is programmed to apply a filter to dampen the music and enhance human voices. In some embodiments, the earpiece directly replays the filtered audio portion to the user upon activation. In some implementations, the earpiece further processes the audio portion using speech-to-text and text-to-speech to remove the totality of the non-voice information from the repeated audio portion. In some embodiments, the voice synthesized in the text-to-speech phase may be generated using the original voice in the song as a model.

In some embodiments, the earpiece is connected to a videoconferencing system and receives information from the videoconferencing application regarding speaker names, pictures, and voice fingerprints, as well as how the speakers' representations are arranged on the user's screen. In some examples, upon replay request from the user, the earpiece replays the selected audio portions simulating an audio direction based on the location of the speaker on the screen.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving audio data comprising one or more voices of one or more users present in an environment, wherein a user wearing an earpiece is present in the environment and is distinct from the one or more users;
storing the received audio data in a memory;
based on receiving an input from the user wearing the earpiece, selecting a portion of the audio data to replay, wherein the input is received while the user wearing the earpiece is present in the environment; and
causing, by control circuitry, the selected portion of the audio data to be replayed by the earpiece of the user wearing the earpiece.

2. The method of claim 1, wherein the earpiece comprises the control circuitry, the earpiece corresponding to headphones or a hearing aid, and the input is received via an interface of the earpiece.

3. The method of claim 1, wherein a mobile device comprises the control circuitry, and the input is received via a user interface of the mobile device.

4. The method of claim 1, wherein the memory in which the audio data is stored is a temporary memory having a particular memory capacity, the method further comprising:
identifying at least one of a number of the one or more users or an ambient noise level of the environment; and
based on the particular memory capacity and at least one of the number of the one or more users or the ambient noise level, adjusting one or more parameters of the audio data being stored in the temporary memory.

5. The method of claim 1, wherein the selecting the portion of the audio data to replay comprises:
determining a first timepoint within the audio data that corresponds to when the input was received; and
selecting, as the selected portion of the audio data, a portion of the audio data corresponding to a last portion of the audio data that was detected prior to the first timepoint.

6. The method of claim 5, further comprising:
identifying a particular voice of the one or more voices that was a last voice detected prior to the first timepoint;
determining, from the audio data, a second timepoint, occurring prior to the first timepoint, when a voice segment corresponding to the particular voice during the last portion of the audio data began; and
selecting, as the selected portion of the audio data, a portion of the audio data from the second timepoint to the first timepoint.

7. The method of claim 1, wherein the selecting the portion of the audio data to replay comprises:
determining a first timepoint within the audio data that corresponds to when the input was received; and
selecting, as the selected portion of the audio data, a portion of the audio data from a second timepoint occurring at a predetermined period of time prior to the first timepoint.

8. The method of claim 4, wherein the one or more users comprise a first user and a second user respectively corresponding to a first voice fingerprint and a second voice fingerprint stored in the memory, the method further comprising:
detecting a voice of a new user that is not among the one or more users;
identifying a first number of inputs received in relation to the first voice fingerprint;
identifying a second number of inputs received in relation to the second voice fingerprint;
removing the first voice fingerprint or the second voice fingerprint from the memory based on the first number of inputs and the second number of inputs; and
storing the voice of the new user in the memory.

9. The method of claim 1, wherein the selecting the portion of the audio data to replay comprises:
identifying a portion of the environment based on an estimated gaze of the user wearing the earpiece derived from a head pose of the user wearing the earpiece when the input is received;
identifying a user of the one or more users located at the identified portion of the environment and identifying a voice of the identified user; and
wherein the selecting the portion of the audio data to replay comprises selecting a portion of the audio data corresponding to the identified voice of the identified user detected prior to receiving the input.

10. The method of claim 9, wherein the one or more users are each associated with a voice fingerprint stored in the memory, and wherein the identifying the user of the one or more users located at the identified portion of the environment and identifying the voice of the identified user is completed using a device with a head pose detection interface, the method further comprising:
determining a location of each user of the plurality of users in the environment;
associating each voice fingerprint of the plurality of users with a direction based on the each location of the each user of the plurality of users in the environment;
determining a first voice fingerprint, wherein the first voice fingerprint is the voice fingerprint associated with the portion of the environment based on the estimated gaze of the user wearing the earpiece derived from the head pose of the user wearing the earpiece when the input is received; and
selecting a portion of the audio data beginning with a timepoint of a last time the user of the plurality of users associated with the first voice fingerprint began speaking prior to the timepoint when the input was received and ending with a timepoint of when the user of the plurality of users associated with the first voice fingerprint finished speaking to be the portion of the audio data to replay.

11. The method of claim 1, wherein causing the portion of the audio data to be replayed further comprises altering the portion of the audio data to cause one or more of removing background noise, translating the portion of the audio data into another language, or changing a speed of the replay of the portion of the audio data.

12. The method of claim 1, wherein the selecting the portion of the audio data to replay comprises:
determining a relevance of each portion of the audio data by:
determining one or more entities within each portion of the audio data using natural language processing; and
comparing the one or more entities within each portion of the audio data to information stored in a user profile of the user wearing the earpiece.

13. The method of claim 2, wherein the user interface of the mobile device comprises a timeline indicating the portions of the audio data spoken by each of the one or more users and detected pauses indicating multiple portions spoken by a same user of the one or more users, and wherein the input comprises selecting a timepoint on the timeline.

14. A device comprising:
a memory; and
control circuitry configured to:
receive audio data comprising one or more voices of one or more users present in an environment, wherein a user wearing an earpiece is present in the environment and is distinct from the one or more users;
store the received audio data in the memory;
based on receiving an input from the user wearing the earpiece, select a portion of the audio data to replay, wherein the input is received while the user wearing the earpiece is present in the environment; and
cause the selected portion of the audio data to be replayed by the earpiece of the user wearing the earpiece.

15. The device of claim 14, wherein the device comprises the earpiece, the earpiece corresponding to headphones or a hearing aid.

16. The device of claim 14, wherein the device comprises a mobile device.

17. The device of claim 14, wherein the memory in which the audio data is stored is a temporary memory having a particular memory capacity, and wherein the control circuitry is further configured to:
identify at least one of a number of the one or more users or an ambient noise level of the environment; and
based on the particular memory capacity and at least one of the number of the one or more users or the ambient noise level, adjust one or more parameters of the audio data being stored in the temporary memory.

18. The device of claim 14, wherein the control circuitry is further configured to select the portion of the audio data to replay by:
determining a first timepoint within the audio data that corresponds to when the input was received; and
selecting, as the selected portion of the audio data, a portion of the audio data corresponding to a last portion of the audio data that was detected prior to the first timepoint.

19. The device of claim 18, wherein the control circuitry is further configured to:
identify a particular voice of the one or more voices that was a last voice detected prior to the first timepoint;
determine, from the audio data, a second timepoint, occurring prior to the first timepoint, when a voice segment corresponding to the particular voice during the last portion of the audio data began; and
select, as the selected portion of the audio data, a portion of the audio data from the second timepoint to the first timepoint.

20. The device of claim 14, wherein the control circuitry is further configured to select the portion of the audio data to replay by:
determining a first timepoint within the audio data that corresponds to when the input was received; and
selecting, as the selected portion of the audio data, a portion of the audio data from a second timepoint occurring at a predetermined period of time prior to the first timepoint.

21.-65. (canceled)
